(19) United States
(12) Patent Application Publication
(10) Pub. No.: US 2024/0163518 A1
(43) Pub. Date: May 16, 2024

(54) INTERACTION METHOD AND ELECTRONIC DEVICE

(71) Applicant: BEIJING BYTEDANCE NETWORK TECHNOLOGY CO., LTD., Beijing (CN)

(72) Inventors: Wenjing LIU, Beijing (CN); Xuyuan XIANG, Beijing (CN)

(21) Appl. No.: 18/551,089

(22) PCT Filed: Mar. 17, 2022
(86) PCT No.: PCT/CN2022/081298

§ 371 Date: Sep. 18, 2023

(30) Foreign Application Priority Data
Mar. 19, 2021 (CN) 202110297155.6

(51) Int. Cl. H04N 21/475; H04N 21/482

(52) U.S. Cl. CPC H04N 21/4758; H04N 21/4826

(57) ABSTRACT

The present disclosure relates to an interaction method and an electronic device, the method comprising: playing multimedia content in an application program; when playing content in the multimedia content that corresponds to a first time period, displaying a leaderboard interface, the first time period being related to a first object in the multimedia content, and the leaderboard interface comprising a first component; and, in response to receiving a first operation on the first component in the first time period, on the basis of the leaderboard cumulative results of the first object, updating the first component to display in a first position in the leaderboard interface, the first position being related to the ranking of the first object.

The present disclosure is a national stage of International Application No. PCT/CN2022/081298, filed on Mar. 17, 2022, which claims the priority to Chinese patent application No. 202110297155.6, titled “INTERACTION METHOD AND ELECTRONIC DEVICE”, filed on Mar. 19, 2021 with the China National Intellectual Property Administration, both of which are incorporated herein by reference in their entireties.

### FIELD

The present disclosure relates to the field of Internet technology, and in particular to an interaction method and an electronic device.

### BACKGROUND

With the continuous development of Internet technology, a user may enjoy a multimedia content such as a movie, a TV series, a variety show and a song performance through various ways (such as live broadcast) adopted by an application. When the multimedia content is displayed by the application, the user has a demand to participate in the multimedia content, such as supporting an object (a contestant or a variety guest) in the multimedia content. Therefore, how to carry out an in-depth interaction with the user in the multimedia content is an urgent problem to be solved.

### SUMMARY

In order to solve or at least partially solve the above technical problem, an interaction method and an electronic device are provided according to the present disclosure.

In a first aspect, an interaction method is provided according to the present disclosure. The interaction method includes:
playing multimedia content in an application;
in a case that content corresponding to a first time period in the multimedia content is played, displaying a ranking list interface, where the first time period is related to a first object in the multimedia content, and the ranking list interface includes a first component; and
updating the first component to display the first component at a first position of the ranking list interface based on a supporting cumulative result of the first object, in response to receiving a first operation on the first component in the first time period, where the first position is related to a ranking of the first object.

In a possible embodiment, the method further includes: in a case that content corresponding to a second time period in the multimedia content is played, updating and displaying the ranking list interface, where the second time period is related to a second object in the multimedia content, the ranking list interface includes the first component and a second component, and a starting time point of the second time period is later than an ending time point of the first time period; and blocking the second operation in response to a second operation received on the first component in the second time period, or updating the second component to display the second component at a second position of the ranking list interface in response to a third operation received on the second component in the second time period, based on the supporting cumulative result of the first object and a supporting cumulative result of the second object, where the second position is related to a ranking of the second object.

In a possible embodiment, the updating the second component to display the second component at a second position of the ranking list interface based on the supporting cumulative result of the first object and a supporting cumulative result of the second object includes: displaying the first component and the second component in a descending order in the ranking list interface based on the supporting cumulative result of the first object and the supporting cumulative result of the second object.

In a possible embodiment, before the multimedia content is not played, the method further includes: displaying a preview interface in response to receiving a fourth operation, where the preview interface includes a preview content, and the preview content is related to a playing time point of the multimedia content.

In a possible embodiment, the displaying the preview interface includes: dynamically displaying the preview content in the preview interface based on a time difference between a time point corresponding to the fourth operation and the playing time point of the multimedia content.

In a possible embodiment, the preview interface further includes an occupation area corresponding to all objects in the multimedia content.

In a possible embodiment, after play of the multimedia content is finished, the method further includes: playing the multimedia content in response to receiving a fifth operation; and in a case that the multimedia content is played, updating and displaying the ranking list interface in response to receiving a sixth operation, where the ranking list interface includes components corresponding to all objects in the multimedia content.

In a possible embodiment, in a supporting time period for the objects in the multimedia content, the method further includes: updating the first position in response to receiving a seventh operation on the first component.

In a possible embodiment, after a supporting time period for the objects in the multimedia content ends, the method further includes: blocking an eighth operation or associating a social account of the first object in the application, in response to receiving the eighth operation on the first component.

In a possible embodiment, the method further includes: displaying, in the first component, at least one of an icon of the first object, a performer name of the first object, a performance content name of the first object, the supporting cumulative result of the first object and the ranking of the first object, where the first position is influenced by the supporting cumulative result of the first object.

In a second aspect, an electronic device is provided according to the present disclosure. The electronic device includes a memory and a processor. The memory is configured to store program instructions. The processor is configured to invoke the program instructions in the memory to cause the electronic device to perform the interaction method in the first aspect and any possible design of the first aspect.

In a third aspect, a computer storage medium including computer instructions is provided according to the present disclosure. The computer instructions, when executed on an electronic device, cause the electronic device to perform the interaction method in the first aspect and any possible design of the first aspect.

In a fourth aspect, a computer program product is provided according to the present disclosure. The computer program product, when executed on a computer, causes the computer to perform the interaction method in the first aspect and any possible design of the first aspect.

In a fifth aspect, a chip system is provided according to the present disclosure. The chip system includes a processor. When the processor performs computer instructions stored in a memory, an electronic device performs the interaction method in the first aspect and any possible design of the first aspect.

### BRIEF DESCRIPTION OF THE DRAWINGS

The drawings herein are incorporated into the specification and constitute a part of the specification. The drawings show embodiments of the present disclosure. The drawings and the specification are intended to explain the principle of the present disclosure.

In order to more clearly illustrate the embodiments of the present disclosure or the technical solutions in the conventional art, the drawings used in the description of the embodiments or the conventional art are briefly introduced below. It is apparent that, for those skilled in the art, other drawings can be obtained according to the provided drawings without any creative effort.

FIGS. 1A to 1M are schematic diagrams of human-computer interaction interfaces according to embodiments of the present disclosure;

FIG. 2 is a schematic flow chart of an interaction method according to an embodiment of the present disclosure; and

FIG. 3 is a schematic flow chart of an interaction method according to an embodiment of the present disclosure.

### DETAILED DESCRIPTION OF EMBODIMENTS

In order to more clearly understand the above objects, features and advantages of the present disclosure, the solutions of the present disclosure will be further described hereinafter. It should be noted that the embodiments of the present disclosure and the features in the embodiments may be combined with each other in the case of no conflict.

In the following description, numerous specific details are set forth in order to provide thorough understanding of the present disclosure. However, the present disclosure may also be implemented in other ways different from those described here. Obviously, the embodiments in the specification are only a part of the embodiments of the present disclosure, rather than all the embodiments.

Exemplarily, an interaction method and apparatus, a device, a computer storage medium and a computer program product are provided according to the present disclosure. By matching an appearance time point and a performance time period of an object in a premiere stage of a multimedia content, a supporting (voting) function of the object in a ranking list interface may be triggered to be turned on or off. In this way, a user may instantly support the object online while a supporting requirement of the multimedia content is met. Moreover, a ranking of an object that has appeared may be adjusted and displayed in the ranking list interface based on a supporting situation of the user, so that the user may know the ranking of the object that has appeared and a real-time change of the ranking. Thus, the user may really participate in the multimedia content, which improves the enthusiasm of the user to watch the multimedia content and engage in in-depth interaction.

In addition, in an unplayed stage of the multimedia content, a preview interface may be dynamically displayed, to preview information such as a playing time point and a participant of the multimedia content to the user in stages.

In addition, in the premiere stage of the multimedia content, by matching the appearance time point and the performance time period of the object, relevant information of the object may be displayed in the ranking list interface, which is beneficial to gradually reveal all objects in the multimedia content, improve the curiosity of the user about the multimedia content and enhance the attractiveness of the multimedia content.

In addition, in a replay stage of the multimedia content, a rank of all objects may displayed in the ranking list interface, so that the user may fully understand the supporting situation of all objects. Moreover, in a supporting time period of the multimedia content, the supporting function of all objects in the ranking list interface is still turned on, so that the user may continue to supporting for the objects, which is beneficial for the user to adjust the ranking of the object in the ranking list interface in time.

The multimedia content may be understood as a video program or a video performance. The multimedia content may be a real-time recorded content or content recorded in advance, which is not limited in the present disclosure.

The object is a character in the multimedia content. For example, when the multimedia content is a singing performance, the object may be a singer or a group of singers. When the multimedia content is a talk show, the object may be a talk show actor or a group of talk show actors. When the multimedia content is an idol talent show, the object may be a talent show idol or a group of talent show idols or a talent show tutor. When the multimedia content is a TV series or a movie, the object may be an actor.

Moreover, the object may also be a performance segment in the multimedia content. For example, when the multimedia content is a singing performance, the object may be a performance segment of a song. When the multimedia content is a talk show, the object may be a segment of talk show of one actor. When the multimedia content is an idol talent show, the object may be a performance segment of one talent show idol/one group of talent show idols. When the multimedia content is a TV series or a movie, the object may be a performance segment of an actor.

The premiere stage of the multimedia content may be understood as a time period in which an application plays the multimedia content for the first time, and the replay stage of the multimedia content may be understood as a remaining time period in addition to and after the premiere stage.

The interaction method according to the present disclosure is performed by an electronic device. The electronic device may be the internet of things (IOT) devices, such as, a tablet computer, a mobile phone (such as a folding screen mobile phone, a large screen mobile phone or the like), a wearable device, a vehicle-mounted device, an augmented reality (AR)/virtual reality (VR) device, a notebook computer, an ultra-mobile personal computer (UMPC), a netbook, a personal digital assistant (PDA), a smart TV, a smart screen, a high-definition TV, a 4K TV, a smart speaker and a smart projector. The type of the electronic device is not limited in the present disclosure.

The type of an operating system of the electronic device is not limited in the present disclosure, which may be for example Android system, Linux system, Windows system, iOS system and the like.

Based on the foregoing description, the interaction method according to the present disclosure is described in detail in combination with the drawings and application scenarios by taking the electronic device as an example in the embodiments of the present disclosure.

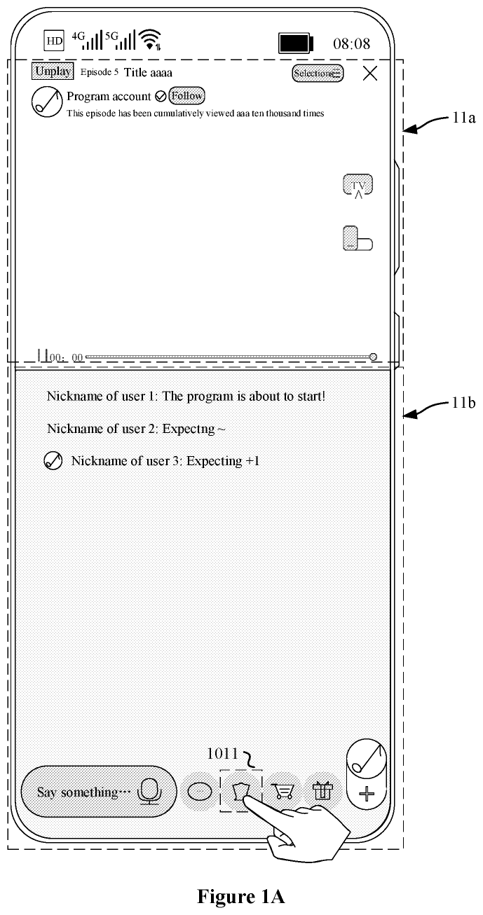

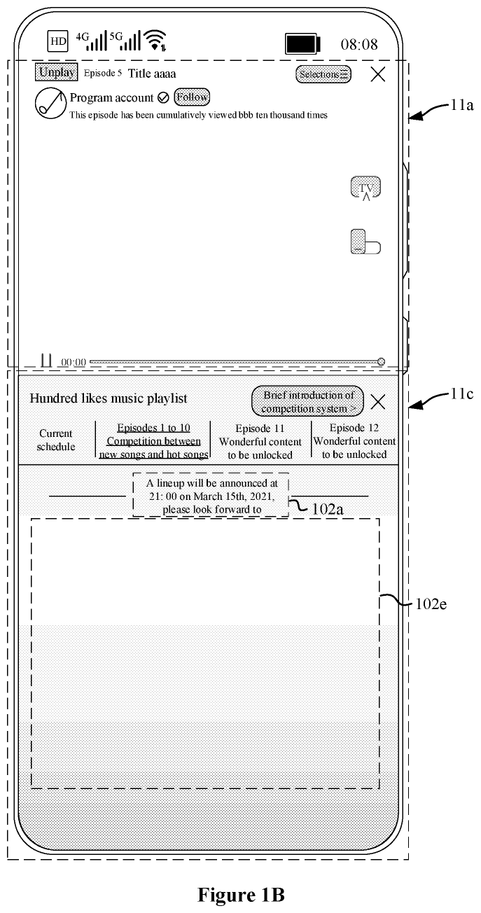

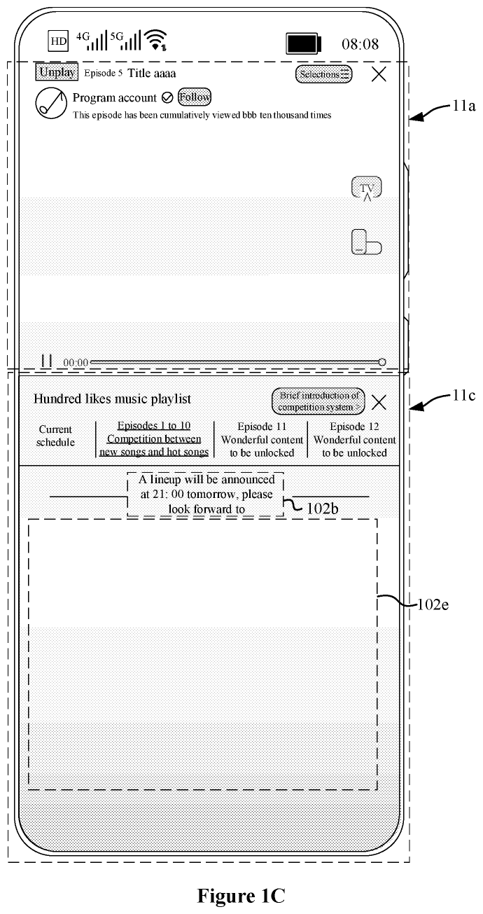

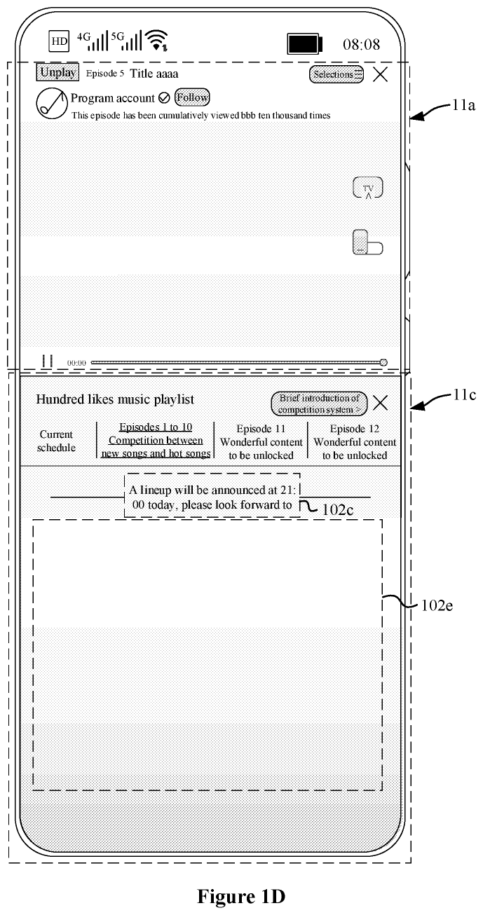

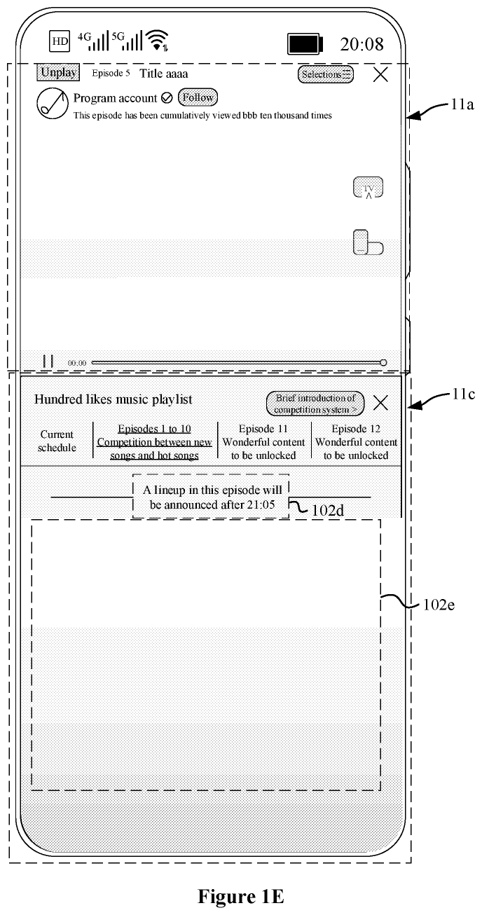

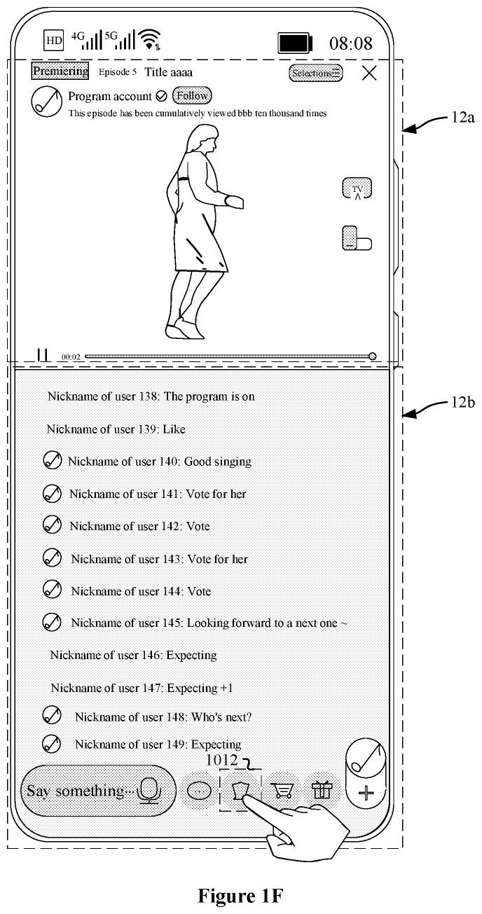

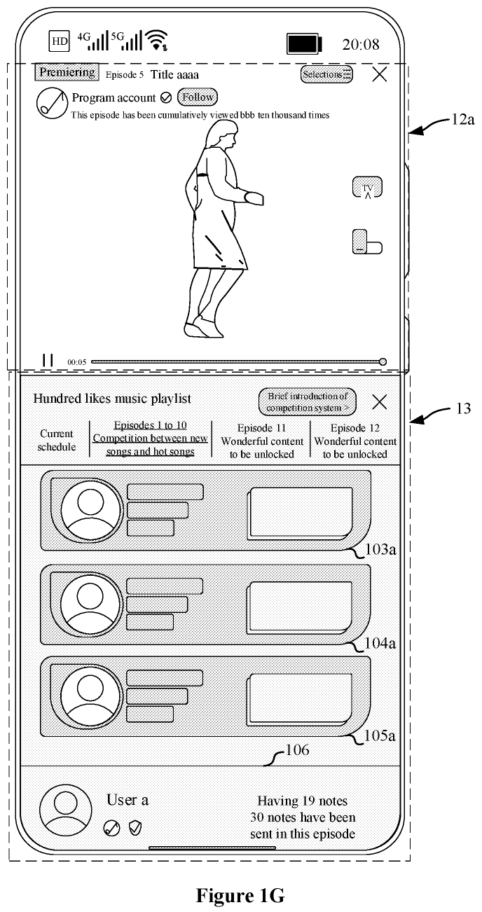

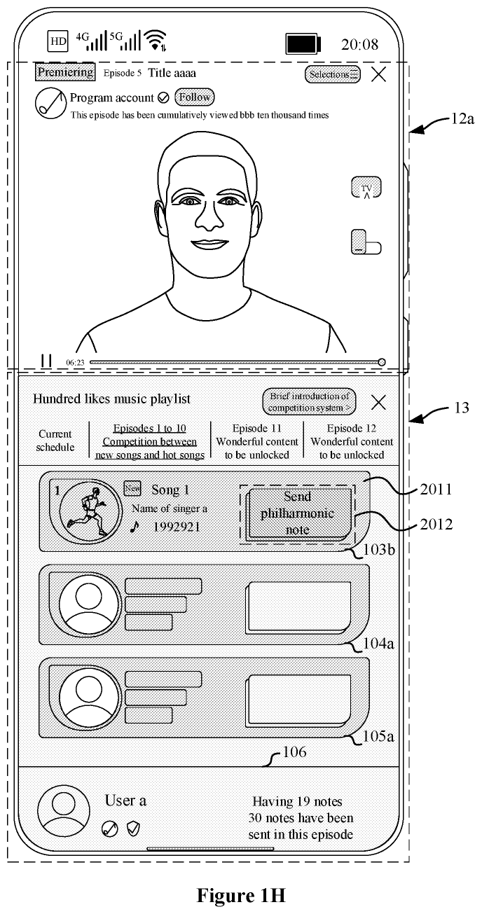

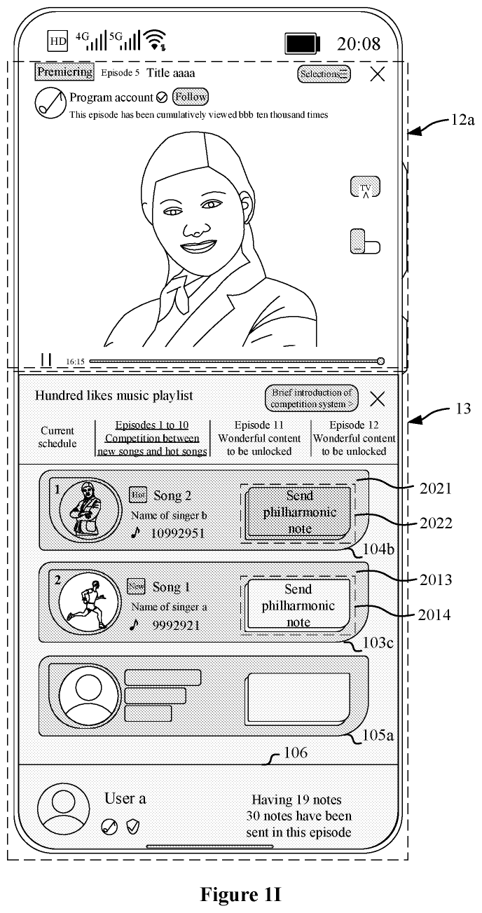

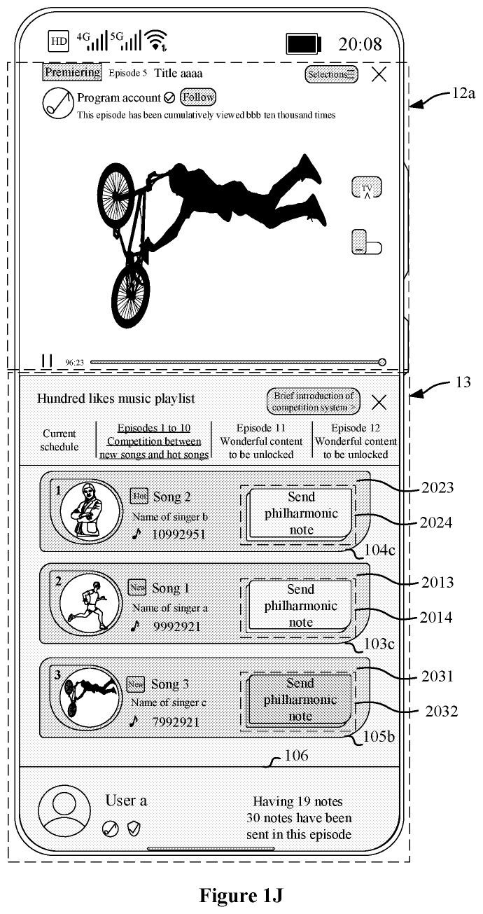

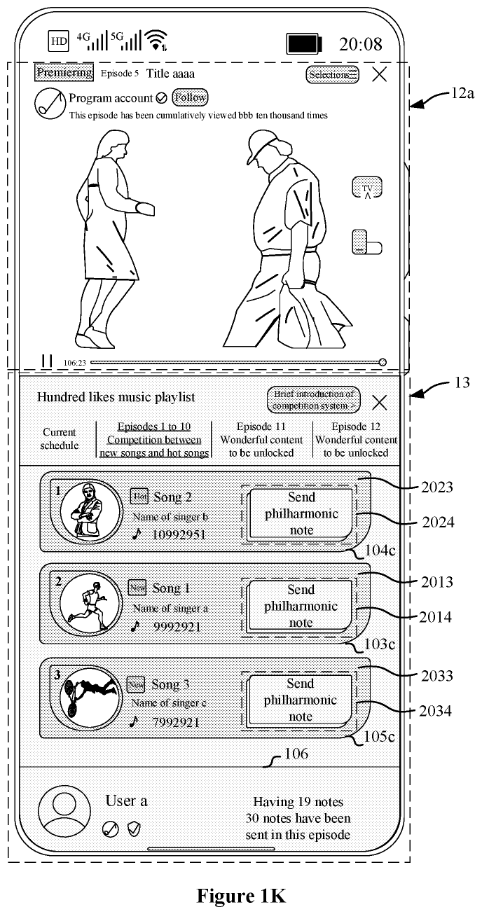

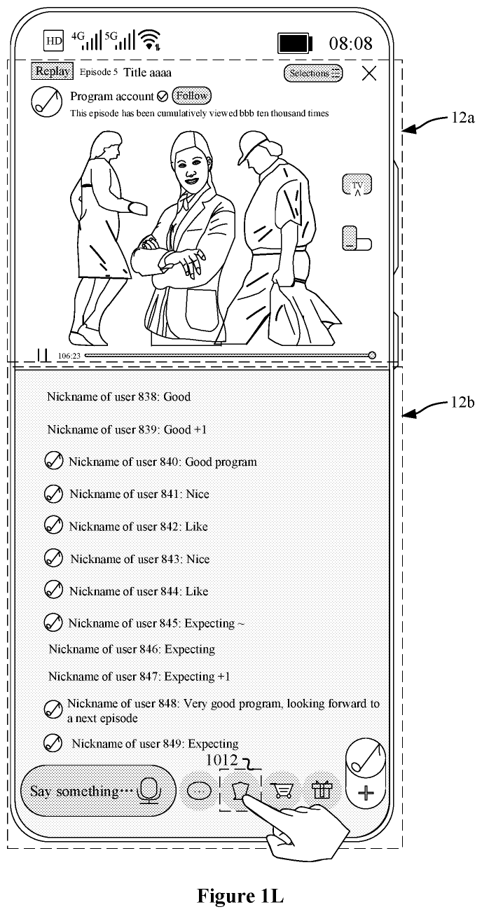

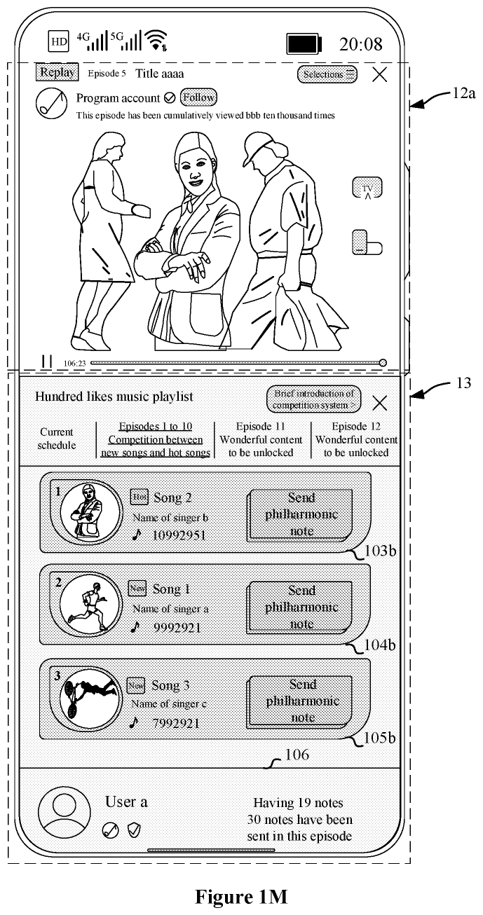

In combination with FIGS. 1A to 1M, a specific implementation process of an interaction method according to the present disclosure is introduced. For convenience of explanation, in FIGS. 1A to 1M, description is made by way of an example in which a mobile phone is used as an electronic device, a short video social application (APP) 1 (hereinafter referred to as an application 1) is installed in the mobile phone. Multiple variety shows of a singer's talent show series may be played in the application 1, one variety show is a multimedia content (hereinafter referred to as a program 1), and all objects in the program 1 include a singer 1, a singer 2 and a singer 3.

Reference is made to FIGS. 1A to 1M, which are schematic diagrams of human-computer interaction interfaces according to embodiments of the present disclosure.

### I. Unplayed Stage of Program 1

For an application 1, after an operation performed by a user to access a program 1 at a time point in an unplayed stage of the program 1 is received, a user interface exemplarily shown in FIG. 1A may be displayed in the application 1 on a mobile phone. The user interface is configured to display the program 1.

The user interface may include an unplayed interface 11a and a comment interface 11b. Parameters such as an area size, an area shape and an area position of the unplayed interface 11a and the comment interface 11b are not limited in the present disclosure. For example, the unplayed interface 11a is on the top of a screen of the mobile phone, and the comment interface 11b is on the bottom of the screen of the mobile phone.

The unplayed interface 11a is configured to display a playing image corresponding to other recorded variety shows except for the program 1 in multiple variety shows, so that a user may watch other recorded variety shows.

Moreover, the unplayed interface 11a is further configured to display a program account of the multiple variety shows in the application 1, an attention button used to associate the program account; the number of views of a currently played variety show; a play state of a currently played variety show; a number, a title, a viewing progress, a viewing duration of episode in a singer's talent show series; and other contents. In addition, the unplayed interface 11a is further configured to provide a control related to the currently played variety show, such as a control for adjusting a playing progress, a control for putting the variety show on other electronic devices, a control for closing the variety show, a control for switching from displaying the variety show on a vertical screen to displaying the variety show on a horizontal screen, a control for selecting other episode of variety shows and the like.

The comment interface 11b is configured to display comment content of the user on the multiple episodes of variety shows, to publish and share opinions of the user related to the multiple episodes of variety shows. A way for displaying the comment content on the comment interface 11b is not limited in the present disclosure. For example, in chronological order, comment contents are displayed one by one from the top of the comment interface 11b in a scrolling manner. In the case that the number of comment contents exceeds a preset threshold, comment content with the longest display time may automatically disappear, and the latest comment content may be displayed at the bottom of the comment interface 11b.

Moreover, a control related to the multiple episodes of variety shows may be provided on the comment interface 11b, such as a control for providing a comment, a control for viewing all comment contents, a control 1011 for viewing a preview interface, a control for purchasing a supporting prop, a control for following the program account, a control for accessing a page corresponding to the program account and the like.

It should be noted that, in addition to the above display mode, the user interface may also be displayed in a display mode including only the unplayed interface 11a or other display modes, which is not limited in the present disclosure.

### 1. Display of Preview Interface

After the application 1 receives an operation such as clicking the control 1011 performed by the user on the comment interface 11b shown in FIG. 1A, display of the comment interface 11b may be changed to display of a preview interface 11c exemplarily shown in any one of FIGS. 1B to 1E. The preview interface 11c is used to preview a playing time point of the program 1.

The preview interface 11c may include preview content related to the playing time point of the program 1. For example, the preview content is displayed in a form of a word and/or a picture. Moreover, a specific display content of the preview content is not limited in the present disclosure.

In some embodiments, the application 1 may dynamically display the preview content in the preview interface 11c, based on a time difference between the playing time point of the program 1 and a time point when the preview interface 11c is displayed in response to a user operation.

The time difference may affect specific display content of the preview content. In some embodiments, in the application 1, the time difference may be divided into four stages (before one day before a play date, one day before the play date, on the play date and more than 1 hour from the playing time point of the program 1, and on the play date and less than 1 hour from the playing time point of the program 1), and respective preview content may be displayed at different stages.

Hereinafter, in conjunction with FIGS. 1B to 1E, preview contents in the four stages are introduced in detail.

Stage 1: the time difference being greater than 1 day (i.e., before one day before the play date)

In the application 1, a preview content 102a, i.e., “a singer lineup will be announced on x year, x month, x day, please look forward to” may be displayed in the preview interface 11c shown in FIG. 1B.

Stage 2: the time difference being equal to 1 day (i.e., one day before the play date)

In the application 1, a preview content 102b, i.e., “a singer lineup will be announced tomorrow at x o'clock, please look forward to” may be displayed in the preview interface 11c shown in FIG. 1C.

Stage 3: the time difference being more than 1 hour and less than 1 day (i.e., on the play day and more than 1 hour from the playing time point of the program 1)

In the application 1, a preview content 102c, i.e., “a singer lineup will be announced today at x o'clock, please look forward to” may be displayed in the preview interface 11c shown in FIG. 1D.

Stage 4: the time difference being greater than 0 and less than or equal to 1 hour (i.e., on the play day and less than or equal to 1 hour from the playing time point of the program 1)

For the application 1, a preview content 102d, i.e., “a singer lineup in this episode will be announced after xx:xx” may be displayed in the preview interface 11c shown in FIG. 1E.

To sum up, in the unplayed stage of the program 1, the application 1 may preview the playing time point of the program 1 to the user in stages, so that the user may fully know the playing time point of the program 1 and the page content of the application is also enriched.

### 2. Display of a Lineup of all Singers in Program 1

In addition to the preview content, the preview interface 11c in FIGS. 1B to 1E may further include an occupation area 102e corresponding to all singers in the program 1, so that the user may know the number of singers in the program 1, thus revealing the number of singers in the program 1 in advance and increasing the attraction of the multimedia content to the user.

A specific implementation of the occupation area 102e corresponding to all singers is not limited in the present disclosure. For example, the occupation area 102e corresponding to all singers is displayed with three identical patterns.

In addition, the application 1 may selectively display the occupation area 102e corresponding to all singers based on the time difference. For example, the occupation area 102e corresponding to all singers is not shown in FIGS. 1B to 1C, but is shown in FIGS. 1D to 1E.

### II. Premiere Stage of Program 1

After the application 1 receives an operation performed by the user to access the program 1 at a time point in a premiere stage of the program 1 (a playing time point of the program 1 in FIG. 1F), a user interface exemplarily shown in FIG. 1F may be displayed on the mobile phone. The user interface may include a playing interface 12a and a comment interface 12b.

Parameters such as an area size, an area shape and an area position of the playing interface 12a and the comment interface 12b are not limited in the present disclosure. For example, the playing interface 12a is on the top of the screen of the mobile phone, and the comment interface 12b is on the bottom of the screen of the mobile phone.

The playing interface 12a is configured to display a playing image of the program 1, so that the user may watch the program 1. Moreover, the playing interface 12a is further configured to display a program account of the multiple variety shows in the application 1; an following button used to associate the program account; the number of views of the program 1; a play state of the program 1; a number, a title, a viewing progress and a viewing duration of episode in a singer's talent show series; and other contents. In addition, the playing interface 12a is further configured to provide a control related to the program 1, such as a control for adjusting a playing progress of the program 1, a control for putting the program 1 on other electronic devices, a control for closing display of the program 1, a control for switching from displaying the program 1 on a vertical screen to displaying the program 1 on a horizontal screen, a control for selecting other variety shows belonging to the same series as the program 1 and the like.

The comment interface 12b is configured to display comment content of the user on the program 1, so that the user may publish and share an opinion related to the program 1. A way for displaying the comment content on the comment interface 12b is not limited in the present disclosure. For example, in chronological order, comment contents are displayed one by one from the top of the comment interface 12b in a scrolling manner. In the case that the number of comment contents exceeds a preset threshold, comment content with a longest display time may automatically disappear, and the latest comment content may be displayed at the bottom of the comment interface 12b.

Moreover, a control related to the program 1 may be provided on the comment interface 12b, such as a control for providing a comment on the program 1, a control for viewing all comment contents, a control 1012 for viewing a ranking list interface, a control for purchasing a supporting prop, a control for following the program account of the program 1 and accessing a page corresponding to the program account of the program 1 and the like.

It should be noted that the unplayed interface 11a and the playing interface 12a are the same interface in different states, and the controls and the areas with the same function in the unplayed interface 11a and the playing interface 12a may be displayed in the same way. The comment interface 11b and the comment interface 12b are the same interface, but the control 1011 and the control 1012 have different functions. In addition to the above display mode, the user interface may also be displayed in a display mode including only the playing interface 12a.

### 1. Initial State of Ranking List Interface

After the application 1 receives an operation such as clicking the control 1012 performed by the user on the comment interface 12b shown in FIG. 1F, display of the comment interface 12b may be changed to display of a ranking list interface 13 exemplarily shown in FIG. 1G The ranking list interface 13 is configured to display a ranking of the singer in the program 1.

The ranking list interface 13 may not display content at present, and may also display the number of singers in the program 1 through the number of occupation components. For example, in FIG. 1G an occupation component 103a, an occupation component 104a and an occupation component 105a may be displayed in the ranking list interface 13. In the case that the user cannot perform a sliding operation on the ranking list interface 13, the three occupation components in the ranking list interface 13 may indicate that there are three singers in the program 1.

Parameters such as content, a position and a size of the ranking list interface 13 are not limited in the present disclosure. The occupation components in the ranking list interface 13 may be displayed in the same pattern. In addition, other contents may be displayed in the ranking list interface 13, which is not limited in the present disclosure. For example, in FIG. 1G an area 106 may be displayed on the ranking list interface 13, on which an avatar of the user, a nickname of the user, and the number of remaining supporting props of the user (i.e., the number of remaining times of the user supporting the singer) may be displayed.

### 2. Display of Ranking of Singer 1 in Ranking List Interface

With the continuous playing of the program 1, in the case that the singer 1 appears in the playing interface 12a or in a playing time period of the singer 1, display of the occupation component 103a in the ranking list interface 13 may be changed to display of a display component 103b exemplarily shown in FIG. 1H in the application 1.

The display component 103b is configured for the user to support the singer 1 in the playing time period of the singer 1 (supporting herein may be understood as the user sending a supporting prop “philharmonic note” to the singer 1). Moreover, parameters such as a position and a style of the display component 103b are not limited in the present disclosure.

In FIG. 1H, the display component 103b includes a display area 2011 and a control 2012.

The display area 2011 is optional. An avatar of the singer 1, a name of a song performed by the singer 1, a name of the singer 1, a real-time supporting cumulative result of the singer 1, a ranking of the singer 1 and other related contents may be displayed in the display area 2011. The control 2012 is configured for the user to support the singer 1 in the playing time period of the singer 1. Moreover, after receiving an operation performed by the user on the control 2012, the application 1 may update the supporting cumulative result of the singer 1 in real time.

Since only singer 1 exists in the playing time period of the program 1, the display component 103b is displayed above the occupation component 104a and the occupation component 105a, i.e., at the top of the ranking list interface 13.

Thus, the position of the display component 103b in the ranking list interface 13 indicates the ranking of the singer 1 in real time.

### 3. Display of Rankings of Singer 1 and Singer 2 in Ranking List Interface

With the continuous playing of the program 1, in the case that a singer 2 appears in the playing interface 12a or in a playing time period of the singer 2, in the application 1, display of the occupation component 103a in the ranking list interface 13 may be changed to display of a display component 104b exemplarily shown in FIG. 1I, and display of the display component 104a in the ranking list interface 13 may be changed to display of a display component 103c exemplarily shown in FIG. 1I.

The display component 104b is configured for the user to support the singer 2 in the playing time period of the singer 2 (supporting herein may be understood as the user sending a supporting prop “philharmonic note” to the singer 2). Moreover, parameters such as a position and a style of the display component 104b are not limited in the present disclosure.

In FIG. 1I, the display component 104b includes a display area 2021 and a control 2022.

The display area 2021 is optional. The display area 2021 is configured to display an avatar of the singer 2, a name of a song performed by the singer 2, a name of the singer 2, a real-time supporting cumulative result of the singer 2, a ranking of the singer 2 and other contents. The control 2022 is configured for the user to support the singer 2 in the playing time period of the singer 2. Moreover, after receiving an operation performed by the user on the control 2022, the application 1 may update the supporting cumulative result of the singer 2 in real time.

The display component 103c is configured to display a supporting situation of the singer 1 in the playing time period of the singer 1, and may not be used for the user to support the singer 1 in the playing time period of the singer 1. Moreover, parameters such as a position and a style of the display component 103c are not limited in the present disclosure.

In FIG. 1I, the display component 103c includes a display area 2013 and a control 2014.

The display area 2013 is optional. The display area 2013 is configured to display an avatar of the singer 1, a name of a song performed by the singer 1, a name of the singer 1, a final supporting cumulative result of the singer 1, a ranking of the singer 1 and other contents. The control 2014 may not be used for the user to support the singer 1 in the playing time period of the singer 1. That is, after receiving an operation performed by the user on the control 2014, the application 1 may block the operation.

It should be noted that the display component 103b may be changed to the display component 103c, at other time points except a time point in which the singer 2 appears in the playing interface 12a or the playing time period of the singer 2, as long as a time point for changing the display component 103b to the display component 103c is ensured after the end of the playing time period of the singer 1.

Since the singer 1 and the singer 2 exist in the playing time period of the program 1, the application 1 may determine positions of the display component 103c, the display component 104b and the occupation component 105a in the ranking list interface 13, based on the final supporting cumulative result of the singer 1 and the real-time supporting cumulative result of the singer 2. For example, in FIG. 1I, the display component 104b, the display component 103c and the occupation component 105a are sequentially displayed in the ranking list interface 13 on the application 1 in order from top to bottom.

Thus, the position of the display component 103c in the ranking list interface 13 indicates the ranking of the singer 1 in real time, and the position of the display component 104b in the ranking list interface 13 indicates the ranking of the singer 2 in real time. Therefore, on the basis of the final supporting cumulative result of the singer 1 and the real-time supporting cumulative result of the singer 2, the ranking of the singers in the ranking list interface 13 may be refreshed in real time, which is beneficial for the user to obtain an accurate ranking list situation.

### 4. Display of Rankings of Singer 1, Singer 2 and Singer 3 in Ranking List Interface

With the continuous playing of the program 1, in the case that a singer 3 appears in the playing interface 12a or in a playing time period of the singer 3, in the application 1, display of the occupation component 105a in the ranking list interface 13 may be changed to display of a display component 105b exemplarily shown in FIG. 1J, and display of the display component 104b in the ranking list interface 13 may be changed to display of a display component 104c exemplarily shown in FIG. 1J.

The display component 105b is configured for the user to support the singer 3 in the playing time period of the singer 3 (supporting herein may be understood as the user sending a supporting prop “philharmonic note” to the singer 3). Moreover, parameters such as a position and a style of the display component 105b are not limited in the present disclosure.

In FIG. 1J, the display component 105b includes a display area 2031 and a control 2032.

The display area 2031 is optional. The display area 2031 is configured to display an avatar of the singer 3, a name of a song performed by the singer 3, a name of the singer 3, a real-time supporting cumulative result of the singer 3, a ranking of the singer 3 and other contents. The control 2032 is configured for the user to support the singer 3 in the playing time period of the singer 3. Moreover, after receiving an operation performed by the user on the control 2032, the application 1 may update the supporting cumulative result of the singer 3 in real time.

The display component 104c is configured to display a supporting situation of the singer 2 in the playing time period of the singer 2, and may not be used for the user to support the singer 2 in the playing time period of the singer 2. Moreover, parameters such as a position and a style of the display component 104c are not limited in the present disclosure.

In FIG. 1J, the display component 104c includes a display area 2023 and a control 2024.

The display area 2023 is optional. The display area 2023 is configured to display an avatar of the singer 2, a name of a song performed by the singer 2, a name of the singer 2, a final supporting cumulative result of the singer 2, a ranking of the singer 2 and other contents.

The control 2024 may not be used for the user to support the singer 2 in the playing time period of the singer 2. That is, after receiving an operation performed by the user on the control 2024, the application 1 may block the operation.

It should be noted that the display component 104b may be changed to the display component 104c at other time points except a time point in which the singer 3 appears in the playing interface 12a or the playing time period of the singer 3, as long as a time point for changing the display component 104b to the display component 104c is ensured after the end of the playing time period of the singer 2.

Since the singer 1, the singer 2 and the singer 3 exist in the playing time period of the program 1, the application 1 may determine positions of the display component 103c, the display component 104c and the display component 105b in the ranking list interface 13, based on the final supporting cumulative result of the singer 1, the final supporting cumulative result of the singer 2 and the real-time supporting cumulative result of the singer 3. For example, in FIG. 1J, the display component 104c, the display component 103c and the display component 105b are sequentially displayed in the ranking list interface 13 on the application 1, in order from top to bottom.

Thus, the position of the display component 103c in the ranking list interface 13 indicates the ranking of the singer 1 in real time, the position of the display component 104c in the ranking list interface 13 indicates the ranking of the singer 2 in real time, and the position of the display component 105b in the ranking list interface 13 indicates the ranking of the singer 3 in real time. Therefore, on the basis of the final supporting cumulative result of the singer 1, the final supporting cumulative result of the singer 2 and the real-time supporting cumulative result of the singer 3, a ranking of the singers in the ranking list interface 13 may be refreshed in real time, which is beneficial for the user to obtain an accurate ranking list situation in time.

With the continuous playing of the program 1, in the case that the playing time period of the singer 3 ends or in the case that the playing time period of the program 1 ends, in the application 1, display of the display component 105b in the ranking list interface 13 may be changed to display of a display component 105c exemplarily shown in FIG. 1K.

The display component 105c is configured to display a supporting situation of the singer 3 in the playing time period of the singer 3, and may not be used for the user to support the singer 3 in the playing time period of the singer 3. Moreover, parameters such as a position and a style of the display component 105c are not limited in the present disclosure.

In FIG. 1K, the display component 105c includes a display area 2033 and a control 2034.

The display area 2033 is optional. The display area 2033 is configured to display an avatar of the singer 3, a name of a song performed by the singer 3, a name of the singer 3, a final supporting cumulative result of the singer 3, a ranking of the singer 3 and other contents. The control 2034 may not be used for the user to support the singer 3 in the playing time period of the singer 3. That is, after receiving an operation performed by the user on the control 2034, the application 1 may block the operation.

Furthermore, for the application 1, positions of the display component 103c, the display component 104c and the display component 105c in the ranking list interface 13 may be determined based on the final supporting cumulative results of the singer 1, the singer 2 and the singer 3.

For example, in FIG. 1K, the display component 103c, the display component 104c and the display component 105c are sequentially displayed in the ranking list interface 13 on the application 1, in order from top to bottom.

Thus, the position of the display component 103c in the ranking list interface 13 indicates the ranking of the singer 1 in real time, the position of the display component 104c in the ranking list interface 13 indicates the ranking of the singer 2 in real time, and the position of the display component 105c in the ranking list interface 13 indicates the ranking of the singer 3 in real time. Therefore, on the basis of the final supporting cumulative results of the singer 1, the singer 2 and the singer 3, a final ranking of the singers in the ranking list interface 13 may be displayed.

It should be noted that besides the display mode described in the above embodiments, after the application 1 receives an operation of clicking one of the control 2012 in FIG. 1H, the control 2022 in FIG. 1I and the control 2032 in FIG. 1J by the user is received, a supporting operation process of the user may be displayed using a dynamic effect, such as the number N for the user supporting for the singer is displayed in a way of “+N”. Moreover, the application 1 may change the supporting cumulative result and the ranking of the singer based on the number N, thus enriching a page content of the application.

Furthermore, in addition to the function described in the above embodiments, the control 2014 in FIG. 1I, the control 2024 in FIG. 1J and the control 2034 in FIG. 1K may be further configured to associate a social account of the singer in the application 1. For example, the control 2014 is configured to associate a social account of the singer 1 in the application 1, the control 2024 is configured to associate a social account of the singer 2 in the application 1, and the control 2034 is configured to associate a social account of the singer 3 in the application 1.

To sum up, in a premiere stage of a program 1, in a playing time period of one singer, a component may be displayed in a ranking list interface on the application 1. The component has a function for a user to support the singer in the playing time period of the singer, so that the user may support the singer online in time by an operation on the component. After the playing time period of the singer ends, the component may be displayed in the ranking list interface on the application 1 continuously, and the component does not have the function for the user to support the singer, so that the user may know a ranking of the singer by a position of the component. Therefore, an interaction degree for the user to closely participate in the program 1 is improved.

### III. Replay Stage of Program 1

After the application 1 receives an operation performed by the user to access the program 1 at a time point in a replay stage of the program 1, a user interface exemplarily shown in FIG. 1L may be displayed by the application 1 on the mobile phone. The user interface may include a playing interface 12a and a comment interface 12b.

The playing interface 12a in FIG. 1L is different from the playing interface 12a in FIG. 1F in that the playing interface 12a in FIG. 1L shows that the play state of the program 1 is in a replay stage, while the playing interface 12a in FIG. 1F shows that the play state of the program 1 is in a premiere stage, and the functions of other areas in the playing interface 12a are basically the same.

After an operation such as clicking the control 1012 performed by the user on the comment interface 12b shown in FIG. 1L is received, the application 1 may determine whether a supporting time period of the program 1 ends. The supporting time period may be understood as an effective time period in which the user may support the singers in the program 1.

On the one hand, in the case that it is determined that the supporting time period of the program 1 has not ended, in the application 1, display of the comment interface 12b may be changed to display of the ranking list interface 13 exemplarily shown in FIG. 1M. The ranking list interface 13 is configured to display a current ranking of the singer in the program 1 and configured for the user to continue to support the singer in the program 1.

For example, in FIG. 1M, the display component 103b, the display component 104b and the display component 105b may be displayed on the ranking list interface 13.

After an operation of the user on the display component 103b is received, the application 1 may update the supporting cumulative result of the singer 1 and the position of the display component 103b in the ranking list interface 13, to update the ranking of the singer 1 in the singer 1, the singer 2 and the singer 3.

After an operation of the user on the display component 104b is received, the application 1 may update the supporting cumulative result of the singer 2 and the position of the display component 104b in the ranking list interface 13, to update the ranking of the singer 2 in the singer 1, the singer 2 and the singer 3 in real time.

After an operation of the user on the display component 105b is received, the application 1 may update the supporting cumulative result of the singer 3 and the position of the display component 105b in the ranking list interface 13, to update the ranking of the singer 3 in the singer 1, the singer 2 and the singer 3 in real time.

On the other hand, in the case that the supporting time period of the program 1 ends, in the application 1, display of the comment interface 12b may be changed to display of the ranking list interface 13 exemplarily shown in FIG. 1K. The ranking list interface 13 is configured to display the final rankings of the singers in the program 1, and may not be used for the user to continue to support the singers in the program 1.

For example, in FIG. 1K, the display component 103c, the display component 104c and the display component 105c may be displayed in the ranking list interface 13.

After an operation of the user on the display component 103c is received, the application 1 may not update the supporting cumulative result of the singer 1 and the position of the display component 103c in the ranking list interface 13 may not be updated. Therefore, the application 1 may block the operation, or may associate the social account of the singer 1 in the application 1.

After an operation of the user on the display component 104c is received, the application 1 may not update the supporting cumulative result of the singer 2 and the position of the display component 104c in the ranking list interface 13. Therefore, the application 1 may block the operation, or may associate the social account of the singer 2 in the application 1.

After an operation of the user on the display component 105c is received, the application 1 may not update the supporting cumulative result of the singer 3 and the position of the display component 105c in the ranking list interface 13. Therefore, the application may block, the operation, or may associate the social account of the singer 3 in the application 1.

Furthermore, the positions of the display component 103c, the display component 104c and the display component 105c in the ranking list interface 13 indicate rankings of the singers 1, 2 and 3, respectively.

To sum up, in the replay stage of a program 1, the rankings of all singers may be displayed in the ranking list interface, so that a user may fully know a supporting situation of all singers. Moreover, in the supporting time period of the program 1, a supporting function for all singers in the ranking list interface is enabled, so that the user may continue to support the singers, which is beneficial for the user to adjust the rankings of the singers in the ranking list interface in time.

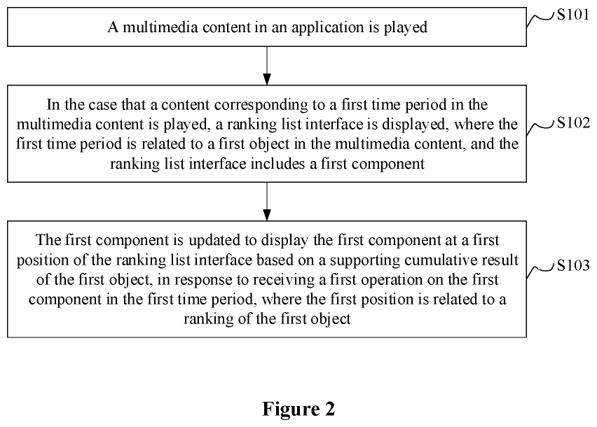

Based on the description of the embodiments in FIGS. 1A to 1M, and in conjunction with FIG. 2, a specific implementation process of an interaction method according to the present disclosure is described in detail.

Reference is made to FIG. 2, which is a schematic flow chart of an interaction method according to an embodiment of the present disclosure. As shown in FIG. 2, the interaction method according to the present disclosure may include the following steps S101 to S103.

In S101, a multimedia content in an application is played.

After starting an application, an electronic device may play a multimedia content in the application. A type of the application as well as a type and a content of the multimedia content are not limited in the present disclosure. For example, the application may be the application 1 in FIGS. 1F to 1M, and the multimedia content may be the program 1 played in the playing interface 12a in the embodiments of FIGS. 1F to 1M.

In S102, in the case that a content corresponding to a first time period in the multimedia content is played, a ranking list interface is displayed, where the first time period is related to a first object in the multimedia content, and the ranking list interface includes a first component.

With the playing of the multimedia content, the electronic device may display a first component in a ranking list interface in the case that the content corresponding to a first time period in the multimedia content is played.

The first object is an object in the multimedia content, which may refer to the description of the previous embodiments and is not repeated here. The first time period may be understood as a playing time period of the first object, i.e., a time period in which the first object participates in a performance, such as a time period from a time when a singer appears on a stage to a time when the singer finishes singing a song. Accordingly, the content corresponding to the first time period is a corresponding playing content in the multimedia content in the playing time period of the first object.

A specific implementation of the ranking list interface is not limited in the present disclosure. Moreover, a first position of the first component in the ranking list interface may indicate a ranking of the first object, and the first component is configured to support the first object in the first time period.

Parameters such as a size, a position, a style and an effect of the first component are not limited in the present disclosure. For example, the style of the first component may be displayed in a form of a word, a letter, a number, an icon, a picture and the like.

In some embodiments, the application is the application 1 in FIGS. 1F to 1M, the multimedia content is the program 1 in the embodiments of FIGS. 1F to 1M, and the first object is the singer 1 in the embodiments of FIGS. 1F to 1M. In this case, the first time period may be understood as a case in which the singer 1 appears in the playing interface 12a in the embodiment of FIG. 1G or the playing time period of the singer 1. A specific implementation of the ranking list interface may refer to the description of the ranking list interface 13 in the embodiment of FIG. 1H, and a specific implementation of the first component may refer to the description of the display component 103b in the embodiment of FIG. 1H, which is not repeated here.

In other embodiments, the application is the application 1 in FIGS. 1F to 1M, the multimedia content is the program 1 in the embodiments of FIGS. 1F to 1M, and the first object is the singer 2 in the embodiments of FIGS. 1F to 1M. In this case, the first time period may be understood as a case in which the singer 2 appears in the playing interface 12a in the embodiment of FIG. 1H or the playing time period of the singer 2. A specific implementation of the ranking list interface may refer to the description of the ranking list interface 13 in the embodiment of FIG. 1I, and a specific implementation of the first component may refer to the description of the display component 104b in the embodiment of FIG. 1I, which is not repeated here.

In other embodiments, the application is the application 1 in FIGS. 1F to 1M, the multimedia content is the program 1 in the embodiments of FIGS. 1F to 1M, and the first object is the singer 3 in the embodiments of FIGS. 1F to 1M. In this case, the first time period may be understood as a case in which the singer 3 appears in the playing interface 12a in the embodiment of FIG. 1I or the playing time period of the singer 3. A specific implementation of the ranking list interface may refer to the description of the ranking list interface 13 in the embodiment of FIG. 1J, and a specific implementation of the first component may refer to the description of the display component 105b in the embodiment of FIG. 1J, which is not repeated here.

In S103, the first component is updated to display the first component at a first position of the ranking list interface based on a supporting cumulative result of the first object, in response to receiving a first operation on the first component in the first time period, where the first position is related to a ranking of the first object.

After receiving a first operation on the first component, the electronic device may know that some users support the first object in the first time period. Furthermore, the electronic device may update a supporting cumulative result of the first object, and the first component is updated to display the first component at a first position of the ranking list interface based on the updated supporting cumulative result of the first object. Thus, a ranking of the first object is refreshed in real time, which is beneficial for the user to know a supporting situation of the object in the multimedia content in time.

The first operation may include, but is not limited to, clicking, double clicking, long pressing, sliding and other types of operations. The first position is influenced by the supporting cumulative result of the first object. The first position indicates the ranking of the first object.

In some embodiments, the application is the application 1 in FIGS. 1F to 1M, the multimedia content is the program 1 in the embodiments of FIGS. 1F to 1M, and the first object is the singer 1 in the embodiments of FIGS. 1F to 1M. In this case, the first operation may be understood as an operation performed by the user on the control 2012 in the embodiment of FIG. 1H, and a specific implementation of the first position may refer to the description of the position of the display component 103b in the ranking list interface 13 in the embodiment of FIG. 1H, which is not repeated here.

In other embodiments, the application is the application 1 in FIGS. 1F to 1M, the multimedia content is the program 1 in the embodiments of FIGS. 1F to 1M, and the first object is the singer 2 in the embodiments of FIGS. 1F to 1M. In this case, the first operation may be understood as an operation performed by the user on the control 2022 in the embodiment of FIG. 1I, and a specific implementation of the first position may refer to the description of the position of the display component 104b in the ranking list interface 13 in the embodiment of FIG. 1I, which is not repeated here.

In other embodiments, the application is the application 1 in FIGS. 1F to 1M, the multimedia content is the program 1 in the embodiments of FIGS. 1F to 1M, and the first object is the singer 3 in the embodiments of FIGS. 1F to 1M. In this case, the first operation may be understood as an operation performed by the user on the control 2032 in the embodiment of FIG. 1J, and a specific implementation of the first position may refer to the description of the position of the display component 105b in the ranking list interface 13 in the embodiment of FIG. 1J, which is not repeated here.

In an interaction method according to the present disclosure, a multimedia content of an application may be played by an electronic device. In the case that content corresponding to a first time period in the multimedia content is played, the electronic device may display a first component in a ranking list interface, the first component has a function of supporting for the first object in the first time period, and the first time period is a playing time period of the first object in the multimedia content. After receiving a first operation on the first component, the electronic device may know that a user supports the first object in the first time period. At this time, the electronic device may update a supporting cumulative result of the first object, and may update a position of the first component in the ranking list interface in real time based on the supporting cumulative result of the first object, so that the user may know a ranking of the first object in time. Therefore, while the multimedia content is played, the ranking of the object in the ranking list interface may be updated in real time by matching an appearance time point and a performance time period of the object, and a close interaction between the user and the multimedia content is achieved, which not only improves the timeliness of the interaction in a process of the user watching the multimedia content, but also enables the multimedia content to have an output of an intellectual property (IP) content in positioning and depth.

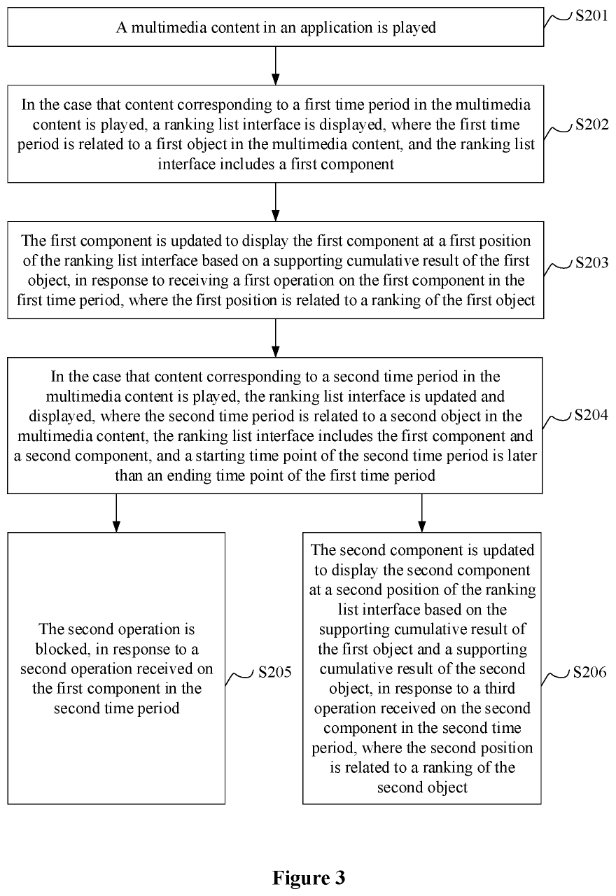

Based on the description of the above embodiments and the embodiment of FIG. 2, in conjunction with FIG. 3, a specific implementation process of an interaction method according to the present disclosure is described in detail.

Reference may be made to FIG. 3, which is a schematic flow chart of an interaction method according to an embodiment of the present disclosure. As shown in FIG. 3, the interaction method according to the present disclosure may include the following steps S201 to S206.

In S201, a multimedia content in an application is played.

In S202, in the case that content corresponding to a first time period in the multimedia content is played, a ranking list interface is displayed, where the first time period is related to a first object in the multimedia content, and the ranking list interface includes a first component.

In S203, the first component is updated to display the first component at a first position of the ranking list interface based on a supporting cumulative result of the first object, in response to receiving a first operation on the first component in the first time period, where the first position is related to a ranking of the first object.

Steps S201 to S203 may refer to the description of steps S101 to S103 in FIG. 2, which will not be repeated herein.

In S204, in the case that content corresponding to a second time period in the multimedia content is played, the ranking list interface is updated and displayed, where the second time period is related to a second object in the multimedia content, the ranking list interface includes the first component and a second component, and a starting time point of the second time period is later than an ending time point of the first time period.

With the continuous playing of the multimedia content, the electronic device may update and display the first component and a second component in the ranking list interface in the case that the content corresponding to a second time period in the multimedia content is played, and the second component is configured to support a second object in the second time period.

The second object is an object in the multimedia content, which is different from the first object and is in the same type as the first object. The starting time point of the second time period is later than the ending time point of the first time period. The second time period may be understood as a playing time period of the second object, i.e., a time period in which the second object participates in a performance, such as a time period from a time when a singer appears on a stage to a time when the singer finishes singing a song. Accordingly, the content corresponding to the second time period is a corresponding playing content in the multimedia content in the playing time period of the second object.

A second position of the second component in the ranking list interface may indicate a ranking of the second object, and the second component is configured to support the second object in the second time period.

Parameters such as a size, a position, a style and an effect of the second component are not limited in the present disclosure. For example, the style of the second component may be displayed in a form of a word, a letter, a number, an icon, a picture and the like.

In some embodiments, the application is the application 1 in FIGS. 1F to 1M, the multimedia content is the program 1 in the embodiments of FIGS. 1F to 1M, the first object is the singer 1 in the embodiments of FIGS. 1F to 1M, and the second object is the singer 2 in the embodiments of FIGS. 1F to 1M. In this case, the second time period may be understood as a case in which the singer 2 appears in the playing interface 12a in the embodiment of FIG. 1H or the playing time period of the singer 2. A specific implementation of the ranking list interface may refer to the description of the ranking list interface 13 in the embodiment of FIG. 1I, a specific implementation of the first component may refer to the description of the display component 103c in the embodiment of FIG. 1I, and a specific implementation of the second component may refer to the description of the display component 104b in the embodiment of FIG. 1I, which will not be repeated herein.

In other embodiments, the application is the application 1 in FIGS. 1F to 1M, the multimedia content is the program 1 in the embodiments of FIGS. 1F to 1M, the first object is the singer 2 in the embodiments of FIGS. 1F to 1M, and the second object is the singer 3 in the embodiments of FIGS. 1F to 1M. In this case, the second time period may be understood as a case in which the singer 3 appears in the playing interface 12a in the embodiment of FIG. 1I or the playing time period of the singer 3. A specific implementation of the ranking list interface may refer to the description of the ranking list interface 13 in the embodiment of FIG. 1J, a specific implementation of the first component may refer to the description of the display component 104c in the embodiment of FIG. 1J, and a specific implementation of the second component may refer to the description of the display component 105b in the embodiment of FIG. 1J, which will not be repeated herein.

In step S204, the electronic device may update the ranking list interface in various ways. In some embodiments, based on supporting information of the first object and supporting information of the second object, the electronic device may display the first component and the second component in a descending order in the ranking list interface. Therefore, it is beneficial for the user to obtain an accurate ranking list situation in time.

The supporting information of the first object is the supporting cumulative result of the first object, and the supporting information of the second object is the supporting cumulative result of the second object.

In S205, the second operation is blocked, in response to a second operation received on the first component in the second time period.

After receiving a first operation on the first component, the electronic device may know that a user supports the first object in the second time period. However, the second time period does not overlap with the first time period, and the starting time point of the second time period is later than the ending time point of the first time period. Thus, the electronic device may not update the supporting cumulative result of the first object. Furthermore, the electronic device may block the second operation, such as no response to the first component, to inform the user that the time period for supporting for the first object has ended.

The second operation may include, but is not limited to, clicking, double clicking, long pressing, sliding and other types of operations.

In some embodiments, the application is the application 1 in FIGS. 1F to 1M, the multimedia content is the program 1 in the embodiments of FIGS. 1F to 1M, and the first object is the singer 1 in the embodiments of FIGS. 1F to 1M. In this case, the second operation may be understood as an operation performed by the user on the control 2014 in the embodiment of FIG. 1I, which is not repeated here.

In other embodiments, the application is the application 1 in FIGS. 1F to 1M, the multimedia content is the program 1 in the embodiments of FIGS. 1F to 1M, and the first object is the singer 2 in the embodiments of FIGS. 1F to 1M. In this case, the second operation may be understood as an operation performed by the user on the control 2024 in the embodiment of FIG. 1J, which is not repeated here.

In S206, the second component is updated to display the second component at a second position of the ranking list interface based on the supporting cumulative result of the first object and a supporting cumulative result of the second object, in response to a third operation received on the second component in the second time period, where the second position is related to a ranking of the second object.

After receiving a third operation on the second component, the electronic device may know that a user supports the second object in the second time period. Furthermore, the electronic device may update a supporting cumulative result of the second object, and positions of the first component and the second component in the ranking list interface may be updated and displayed based on the supporting cumulative result of the first object and the updated supporting cumulative result of the second object. Thus, the rankings of the first object and the second object may be refreshed in real time, which is convenient for the user to know a supporting situation of the object in the multimedia content in time.

The third operation may include, but is not limited to, clicking, double clicking, long pressing, sliding and other types of operations. The second position is influenced by the supporting cumulative result of the second object. The second position indicates the ranking of the second object.

In some embodiments, the application is the application 1 in FIGS. 1F to 1M, the multimedia content is the program 1 in the embodiments of FIGS. 1F to 1M, the first object is the singer 1 in the embodiments of FIGS. 1F to 1M, and the second object is the singer 2 in the embodiments of FIGS. 1F to 1M. In this case, the third operation may be understood as an operation performed by the user on the control 2022 in the embodiment of FIG. 1I. A specific implementation of the first position may refer to the description of the position of the display component 103c in the ranking list interface 13 in the embodiment of FIG. 1I, and a specific implementation of the second position may refer to the description of the position of the display component 104b in the ranking list interface 13 in the embodiment of FIG. 1I, which will not be repeated herein.

In other embodiments, the application is the application 1 in FIGS. 1F to 1M, the multimedia content is the program 1 in the embodiments of FIGS. 1F to 1M, the first object is the singer 2 in the embodiments of FIGS. 1F to 1M, and the second object is the singer 3 in the embodiments of FIGS. 1F to 1M. In this case, the third operation may be understood as an operation performed by the user on the control 2032 in the embodiment of FIG. 1J. A specific implementation of the first position may refer to the description of the position of the display component 104c in the ranking list interface 13 in the embodiment of FIG. 1J, and a specific implementation of the second position may refer to the description of the position of the display component 105b in the ranking list interface 13 in the embodiment of FIG. 1J, which will not be repeated herein.

To sum up, with the continuous playing of a multimedia content, in the case that the content corresponding to a second time period in the multimedia content is played, the electronic device may update and display a first component and a second component in a ranking list interface. After the first operation on the first component is received, because a starting time point of the second time period is later than an ending time point of the first time period, the electronic device does not update the supporting cumulative result of the first object. After receiving the first operation on the second component, the electronic device may update the supporting cumulative result of the second object. At this time, the electronic device may update the supporting cumulative result of the second object, and positions of the first component and the second component in the ranking list interface may be updated based on the supporting cumulative result of the first object and the supporting cumulative result of the second object in real time. Thus, a user may know rankings of the first object and the second object in time. Therefore, in different stages of the multimedia content, supporting contents and supporting states displayed in the ranking list interface have changed accordingly. Therefore, while the supporting requirements are met, the user may clearly know information and trends needed for supporting at each stage, which is helpful for the user to participate in the multimedia content smoothly.

Based on the description of the above embodiments, before the multimedia content is not played, the electronic device may also preview a playing time point of the multimedia content to the user, so that the user may watch the multimedia content on time, thus making the users watch more multimedia content.

In some embodiments, after receiving a fourth operation, the electronic device may display a preview content in a preview interface, and the preview content is related to a playing time point of the multimedia content.

The fourth operation may include, but is not limited to, clicking, double clicking, long pressing, sliding and other types of operations. The preview interface is configured to display information such as a playing time point and a participant of the multimedia content.

The electronic device may dynamically display the preview content in the preview interface, to preview the playing time point of the multimedia content to the user in stages, so that the user may fully know the playing time point of the multimedia content and a page content of the application is enriched.

In some embodiments, the electronic device may dynamically display the preview content in the preview interface based on a time difference between a time point corresponding to the fourth operation and the playing time point of the multimedia content.

Moreover, in addition to the preview content, the preview interface may further include an occupation area corresponding to all objects in the multimedia content, so that the user may know the number of objects in the multimedia content, thus revealing the multimedia content in advance and increasing the attraction of the multimedia content to the user.

In some embodiments, the application is the application 1 in FIGS. 1A to 1E, and the multimedia content is the program 1 in the embodiments of FIGS. 1A to 1E. In this case, the fourth operation may be understood as an operation such as clicking the control 1011 performed by the user on the comment interface 11b shown in FIG. 1A. A specific implementation of the preview interface may refer to the description of the preview interface 11c exemplarily shown in any of FIGS. 1B to 1E, a specific implementation of the preview content may refer to the description of the preview contents 102a to 102d exemplarily shown in any of FIGS. 1B to 1E, and a specific implementation of the occupation area corresponding to all objects in the multimedia content may refer to the description of the occupation area 102e exemplarily shown in any of FIGS. 1B to 1E, which will not be repeated herein.

Based on the foregoing description, after the premiere stage of the multimedia content ends, the electronic device may continue to play the multimedia content in the application, i.e., the multimedia content may be replayed, to attract more users to watch the multimedia content.

In the present disclosure, after receiving a fifth operation, the electronic device may play the multimedia content, i.e., the multimedia content is in a replay stage. The fifth operation may include, but is not limited to, clicking, double clicking, long pressing, sliding and other types of operations. In the case that the multimedia content is played, the electronic device may update and display the ranking list interface in response receiving a sixth operation. The ranking list interface includes components corresponding to all objects in the multimedia content, so that the user may fully know rankings of all objects.

In some embodiments, the above process may refer to the exemplary description of FIGS. 1L to 1K. The fifth operation may be understood as an operation performed by the user to access the program 1 at a time point in a replay stage of the program. The sixth operation may be understood as an operation such as clicking the control 1012 performed by the user on the comment interface 12b shown in FIG. 1L. A specific implementation of the ranking list interface may refer to the description of the ranking list interface 13 exemplarily shown in FIG. 1M or 1K, which is not repeated here.

After receiving the sixth operation, the electronic device may determine whether a supporting time period of the multimedia content ends. The supporting time period may be understood as an effective time period in which the user may support the objects in the multimedia content.

In the supporting time period of the objects in the multimedia content, the electronic device may update and display the ranking list interface. After receiving a seventh operation on the first component, the electronic device may update the first position, thereby displaying the first component in the updated first position in the ranking list interface.

In some embodiments, the above process may refer to the exemplary description of FIGS. 1L to 1M, and a specific implementation of the ranking list interface may refer to the description of the ranking list interface 13 exemplarily shown in FIG. 1M. The seventh operation may be understood as an operation of the user on the display component 103b, and correspondingly, the first component is the display component 103b, and the updated first position is a position of the display component 103b in the ranking list interface 13. Alternatively, the seventh operation may be understood as an operation of the user on the display component 104b, and correspondingly, the first component is the display component 104b, and the updated first position is a position of the display component 104b in the ranking list interface 13. Alternatively, the seventh operation may be understood as an operation of the user on the display component 105b, and correspondingly, the first component is the display component 105b, and the updated first position is a position of the display component 105b in the ranking list interface 13, which will not be repeated herein.

After a supporting time period of the objects in the multimedia content ends, the electronic device may update and display the ranking list interface. After receiving an eighth operation on the first component, the electronic device may block the eighth operation, or the electronic device may associate a social account of the first object in the application.

In some embodiments, the above process may refer to the exemplary description of FIGS. 1L and 1K, and a specific implementation of the ranking list interface may refer to the description of the ranking list interface 13 exemplary shown in FIG. 1K. The eighth operation may be understood as an operation of the user on the display component 103c, and correspondingly, the first component is the display component 103c. Alternatively, the eighth operation may be understood as an operation of the user on the display component 104c, and correspondingly, the first component is the display component 104c. Alternatively, the eighth operation may be understood as an operation of the user on the display component 105c, and correspondingly, the first component is the display component 105c, which will not be repeated herein.

To sum up, in the replay stage of the multimedia content, rankings of all objects may be displayed in the ranking list interface, so that a user may fully know the supporting situation of all objects. Moreover, after the supporting time period of the multimedia content ends, the supporting function of all objects in the ranking list interface is turned off, while in the supporting time period of the multimedia content, the supporting function of all objects in the ranking list interface is turned on, so that the user may continue to supporting the objects, which is beneficial for the user to adjust the rankings of the objects in the ranking list interface in time.

Based on the description of the above embodiments, in addition to displaying the first component in the ranking list interface, the electronic device may display, in the first component, at least one of an icon of the first object, a performer name of the first object, a performance content name of the first object, the supporting cumulative result of the first object and the ranking of the first object. The first position is influenced by the supporting cumulative result of the first object. Therefore, the user may fully know the supporting situation of the object, which is convenient for the user to add the number of supporting for the object.

Exemplarily, an electronic device is provided according to the present disclosure. The electronic device includes one or more processors; a memory; and one or more computer programs, where the one or more computer programs are stored in the memory, and the one or more computer programs, when executed by the one or more processors, cause the electronic device to implement the interaction method in the previous embodiments.

Exemplarily, a chip system is provided according to the present disclosure, which is applied to an electronic device including a memory and a sensor. The chip system includes a processor. The processor performs the interaction method in the previous embodiment.

Exemplarily, a computer readable storage medium on which a computer program is stored is provided according to the present disclosure. The computer program, when executed by a processor, causes an electronic device to implement the interaction method in the previous embodiments.

Exemplarily, a computer program product is provided according to the present disclosure. The computer program product, when executed on a computer, causes the computer to perform the interaction method in the previous embodiments.

In the above embodiments, all or part of the functions may be implemented by software, hardware, or a combination of software and hardware. When the embodiments are implemented by using software, all or some of the embodiments may be implemented in a form of a computer program product. The computer program product includes one or more computer instructions. When the computer program instructions are loaded and executed on a computer, all or some of the processes or functions according to the embodiments of the present disclosure are produced. The computer may be a general-purpose computer, a special-purpose computer, a computer network, or another programmable apparatus. The computer instructions may be stored in a computer readable storage medium. The computer readable storage medium may be any available medium capable of being accessed by a computer or include one or more data storage devices integrated by an available medium, such as a server and a data center. The available medium may be a magnetic medium (such as a floppy disk, a hard disk, or a magnetic tape), an optical medium (such as a DVD), a semiconductor medium (such as a solid state disk (SSD)) or the like.

It should be noted that the relational terms “first”, “second” and the like in the present disclosure are used for distinguishing an entity or operation from another entity or operation, rather than requiring or implying an actual relationship or order between these entities or operations. Further, the terms “include”, “comprise” or any variant thereof are intended to encompass nonexclusive inclusion so that a process, method, article or apparatus including a series of elements includes not only those elements but also other elements which have not been listed definitely or an element(s) inherent to the process, method, article or apparatus. Unless expressively limited otherwise, a process, method, article or apparatus limited by “comprising/including a(an) . . . ” does not exclude existence of another identical element in such process, method, article or apparatus.

The above are only specific implementations of the present disclosure, such that those skilled in the art can understand or implement the present disclosure. It is apparent for those skilled in the art to make various modifications to these embodiments. The general principle defined herein may be applied to other embodiments without departing from the spirit or the scope of the present disclosure. Therefore, the present disclosure is not limited to the embodiments illustrated herein, but should be defined by the broadest scope consistent with the principle and novel features disclosed herein.

1. An interaction method, comprising:
playing a multimedia content;
displaying a ranking list interface, in a case that content corresponding to a first time period in the multimedia content is played, wherein the first time period is related to a first object in the multimedia content, and the ranking list interface comprises a first component; and
updating the first component to display the first component at a first position of the ranking list interface based on a supporting cumulative result of the first object, in response to receiving a first operation on the first component in the first time period, wherein the first position is related to a ranking of the first object.

2. The method according to claim 1, further comprising:
updating and displaying the ranking list interface, in a case that content corresponding to a second time period in the multimedia content is played, wherein the second time period is related to a second object in the multimedia content, the ranking list interface comprises the first component and a second component, and a starting time point of the second time period is later than an ending time point of the first time period; and
blocking a second operation in response to the second operation received on the first component in the second time period; or updating the second component to display the second component at a second position of the ranking list interface based on the supporting cumulative result of the first object and a supporting cumulative result of the second object, in response to a third operation received on the second component in the second time period, wherein the second position is related to a ranking of the second object.

3. The method according to claim 2, wherein the updating the second component to display the second component at a second position of the ranking list interface based on the supporting cumulative result of the first object and the supporting cumulative result of the second object comprises:
displaying the first component and the second component in a descending order in the ranking list interface based on the supporting cumulative result of the first object and the supporting cumulative result of the second object.

4. The method according to claim 1, wherein before the multimedia content is played, the method further comprises:
displaying a preview interface in response to receiving a fourth operation, wherein the preview interface comprises a preview content, and the preview content is related to a playing time point of the multimedia content.

5. The method according to claim 4, wherein the displaying the preview interface comprises:
dynamically displaying the preview content in the preview interface based on a time difference between a time point corresponding to the fourth operation and the playing time point of the multimedia content.

6. The method according to claim 4, wherein the preview interface further comprises an occupation area corresponding to all objects in the multimedia content.

7. The method according to claim 4, wherein after play of the multimedia content is finished, the method further comprises:
playing the multimedia content in response to receiving a fifth operation; and
in a case that the multimedia content is played, updating and displaying the ranking list interface, in response to receiving a sixth operation, wherein the ranking list interface comprises components corresponding to all objects in the multimedia content.

8. The method according to claim 7, wherein in a supporting time period of the objects in the multimedia content, the method further comprises:
updating the first position in response to receiving a seventh operation on the first component.

9. The method according to claim 7, wherein after a supporting time period of the objects in the multimedia content is finished, the method further comprises:
blocking an eighth operation or associating a social account of the first object, in response to receiving the eighth operation on the first component.

10. The method according further comprising:
displaying, in the first component, at least one of an icon of the first object, a performer name of the first object, a performance content name of the first object, the supporting cumulative result of the first object and the ranking of the first object, wherein the first position is influenced by the supporting cumulative result of the first object.

11. An electronic device, comprising:
one or more processors;
a memory; and
one or more computer programs,
wherein the one or more computer programs are stored in the memory, and the one or more computer programs, when executed by the one or more processors, cause the electronic device to
play a multimedia content;
display a ranking list interface, in a case that content corresponding to a first time period in the multimedia content is played, wherein the first time period is related to a first object in the multimedia content, and the ranking list interface comprises a first component; and
update the first component to display the first component at a first position of the ranking list interface based on a supporting cumulative result of the first object, in response to receiving a first operation on the first component in the first time period, wherein the first position is related to a ranking of the first object.

12. A computer storage medium comprising computer instructions, wherein the computer instructions, when executed on an electronic device, cause the electronic device to:
play a multimedia content;
display a ranking list interface, in a case that content corresponding to a first time period in the multimedia content is played, wherein the first time period is related to a first object in the multimedia content, and the ranking list interface comprises a first component, and
update the first component at a first position of the ranking list interface based on a supporting cumulative result of the first object, in response to receiving a first operation on the first component in the first time period, wherein the first position is related to a ranking of the first object.

13. (canceled)

14. The electronic device according to claim 11, wherein the computer instructions, when executed on an electronic device, cause the electronic device to:
update and display the ranking list interface, in a case that content corresponding to a second time period in the multimedia content is played, wherein the second time period is related to a second object in the multimedia content, the ranking list interface comprises the first component and a second component, and a starting time point of the second time period is later than an ending time point of the first time period; and
block a second operation in response to the second operation received on the first component in the second time period; or update the second component to display the second component at a second position of the ranking list interface based on the supporting cumulative result of the first object and a supporting cumulative result of the second object, in response to a third operation received on the second component in the second time period, wherein the second position is related to a ranking of the second object.

15. The electronic device according to claim 14, wherein the computer instructions, when executed on an electronic device, cause the electronic device further to:
display the first component and the second component in a descending order in the ranking list interface based on the supporting cumulative result of the first object and the supporting cumulative result of the second object.

16. The electronic device according to claim 11, wherein the computer instructions, when executed on an electronic device, cause the electronic device further to:
display a preview interface in response to receiving a fourth operation, before the multimedia content is played, wherein the preview interface comprises a preview content, and the preview content is related to a playing time point of the multimedia content.

17. The electronic device according to claim 16, wherein the computer instructions, when executed on an electronic device, cause the electronic device further to:
dynamically display the preview content in the preview interface based on a time difference between a time point corresponding to the fourth operation and the playing time point of the multimedia content.

18. The electronic device according to claim 16, wherein the preview interface further comprises an occupation area corresponding to all objects in the multimedia content.

19. The electronic device according to claim 11, wherein the computer instructions, when executed on an electronic device, cause the electronic device further to:
play the multimedia content in response to receiving a fifth operation, after play of the multimedia content is finished; and
in a case that the multimedia content is played, update and display the ranking list interface, in response to receiving a sixth operation, wherein the ranking list interface comprises components corresponding to all objects in the multimedia content.

20. The electronic device according to claim 19, wherein the computer instructions, when executed on an electronic device, cause the electronic device further to:
in a supporting time period of the objects in the multimedia content, update the first position in response to receiving a seventh operation on the first component.

21. The electronic device according to claim 19, wherein the computer instructions, when executed on an electronic device, cause the electronic device further to:
after a supporting time period of the objects in the multimedia content is finished, block an eighth operation or associating a social account of the first object, in response to receiving the eighth operation on the first component.
